(19) United States
(12) Patent Application Publication
(10) Pub. No.: US 2005/0275781 A1
(43) Pub. Date: Dec. 15, 2005

(54) Rubbing apparatus for LCD

(75) Inventors: Dae Jung Choi, Seoul (KR); Hyang Yul Kim, Kyoungki-do (KR)

Correspondence Address: SEYFARTH SHAW LLP, 55 EAST MONROE STREET, SUITE 4200, CHICAGO, IL, 60603-5803, US

(73) Assignee: Boe Hydis Technology Co., Ltd.

(21) Appl. No.: 11/086,171

(22) Filed: Mar. 22, 2005

(30) Foreign Application Priority Data
Jun. 14, 2004 (KR) 10-2004-0043570

(51) Int. Cl. G02F 1/1337

(52) U.S. Cl. 349/126

(57) ABSTRACT

A rubbing apparatus has an improved stage for supporting a substrate, so that the rubbing apparatus can manufacture an LCD of high quality while reducing the time and cost for the manufacture of the LCD. The rubbing apparatus comprises: a stage on which a substrate is placed; and a roller for rubbing a composite film coated on the substrate so as to form an orientation film, wherein the stage includes: a suction means for sucking the substrate, the suction means being movable up and down; and a step-covering means surrounding a periphery of the substrate, the step-covering means being horizontally movable.

### BACKGROUND OF THE INVENTION

1. Field of the Invention

The present invention relates to a Rubbing apparatus for a liquid crystal display, and more particularly to a rubbing apparatus has an improved stage for mounting a substrate.

2. Description of the Prior Art

As generally known in the art, in a process of forming a liquid crystal cell in a liquid crystal display (hereinafter, referred to as “LCD”), liquid crystal is injected between a color filter substrate having a color filter layer and a common electrode formed thereon and a thin film transistor (hereinafter, referred to as “TFT”) substrate having a TFT and a pixel electrode formed thereon, and a driving circuit is added to the lamination including the two substrates enclosing the liquid crystal, thereby producing a liquid crystal cell capable of performing image display. Such a process of forming a liquid crystal cell includes an orientation film formation step for orientation of liquid crystal molecules, a cell cap formation step, a liquid crystal injection step, a polarized film attachment step, etc.

From among those steps, in the orientation film formation step, an organic polymer film is artificially formed on a substrate and is then subjected to a mechanical rubbing. Here, in the rubbing, a uniform layer formed by applying polyimide-based polymer composite is rubbed in a predetermined direction by a mechanical rubbing apparatus. Through the rubbing, the liquid crystal molecules on the substrate are aligned in the rubbing direction.

The rubbing apparatus includes a stage on which a flat substrate is placed and a roller for rubbing the substrate.

FIG. 1 is a plan view of a conventional rubbing apparatus rubbing a substrate.

As shown, the conventional rubbing apparatus includes a stage 100 and a roller 120. When a substrate 130 is placed on the stage 110, the roller 120 rubs the substrate 130 in a predetermined direction.

However, when the roller 120 initially moves toward the substrate 130 in order to rub the substrate 130, a step formed between the substrate 130 and the stage 110 may damage rubbing cloth wrapping the roller 120, which is made from cotton or wool of rayon-based fibers. Further, alien materials produced by such damage may be scattered on the substrate 130. Especially when the substrate 130 has an uneven edge, an increased quantity of alien materials may be produced and scattered on the substrate 130. The alien materials scattered on the substrate 130 may degrade the quality of the LCD. Therefore, in order to eliminate the scattered alien materials, the orientation film formed on the substrate 130 is usually eliminated and subjected again to the rubbing. Such a repetitive labor increases the time and cost for manufacturing the LCD.

### SUMMARY OF THE INVENTION

Accordingly, the present invention has been made to solve the above-mentioned problems occurring in the prior art, and an object of the present invention is to provide a rubbing apparatus which has an improved stage for supporting a substrate, so that the rubbing apparatus can manufacture an LCD of high quality while reducing the time and cost for the manufacture of the LCD.

In order to accomplish this object, there is provided a rubbing apparatus for a liquid crystal display device, the rubbing apparatus comprising: a stage on which a substrate is placed; and a roller for rubbing a composite film coated on the substrate so as to form an orientation film, wherein the stage includes: a suction means for sucking the substrate, the suction means being movable up and down; and a step-covering means surrounding a periphery of the substrate, the step-covering means being horizontally and vertically movable.

### BRIEF DESCRIPTION OF THE DRAWINGS

The above and other objects, features and advantages of the present invention will be more apparent from the following detailed description taken in conjunction with the accompanying drawings, in which:

FIG. 1 is a plan view of a conventional rubbing apparatus rubbing a substrate;

FIG. 2A is a side sectional view of a rubbing apparatus according to an embodiment of the present invention, which is rubbing a substrate;

FIG. 2B is a plan view of a rubbing apparatus according to an embodiment of the present invention, which is rubbing a substrate; and

FIG. 3 is a plan view of a rubbing apparatus according to another embodiment of the present invention, which has a step-covering means adjustable according to the size of a substrate.

### DETAILED DESCRIPTION OF THE PREFERRED EMBODIMENTS

Hereinafter, a preferred embodiment of the present invention will be described with reference to the accompanying drawings.

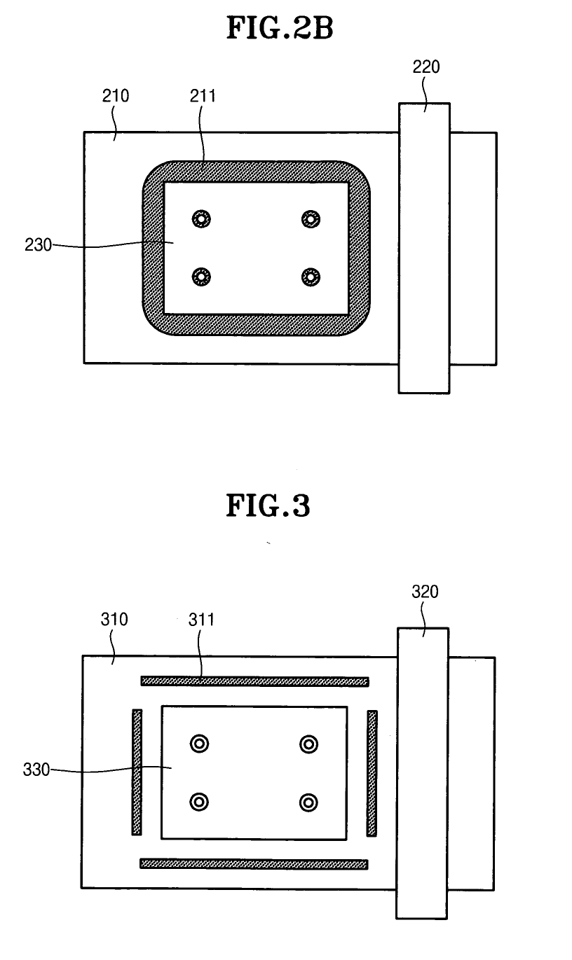

FIG. 2A is a side sectional view of a rubbing apparatus according to an embodiment of the present invention, which is rubbing a substrate.

As shown, the rubbing apparatus includes a stage 210 and a roller 220, and a substrate 230 is placed on the stage 210.

The stage 210 includes a step-covering means 211 and a suction device 213. The step-covering means 211 has an inclined surface a top of which is in contact with a side surface of the substrate 230. The step-covering means 211 enables the roller 220 to smoothly move onto the substrate 230 without being caught or damaged by the step between the substrate 230 and the stage 210. The step-covering means 211 is made from an elastic material such as rubber or Teflon or mixture of an elastic material with additives of polymer or metal. Therefore, as opposed to the prior art, the quantity of the alien materials scattered by the edge of the substrate 230 is remarkably reduced. Further, the suction device 212 sucks the substrate 230 through the suction ports 213 and moves up and down according to the pressure applied to the substrate 230 by the roller 220 during the rubbing.

Hereinafter, a process of rubbing the substrate 230 by the rubbing apparatus will be described.

First, the suction device 212 sucks the substrate 230 through the suction ports 213. That is, the suction device 212 holds the substrate 230 on the substrate 230. Then, the step-covering means 211 is located around and in contact with the periphery of the substrate 230, and the roller 220 moves from the stage 210 to the substrate 230 through the step-covering means 211. Then, the roller 220 rubs the substrate 230, so that the initial orientation of the crystal molecules on the substrate 230 is determined. While the roller 220 rubs the substrate 230, the suction device 213 moves up and down according to the pressure applied to the substrate 230 by the roller 220.

FIG. 2B is a plan view of a rubbing apparatus according to an embodiment of the present invention, which is rubbing a substrate.

As shown, the rubbing apparatus includes a stage 210 and a roller 220, and a substrate 230 is placed on the stage 210. The step-covering means 211 surrounds the periphery of the substrate 230.

The process of rubbing the substrate 230 by the rubbing apparatus is the same as described above.

FIG. 3 is a plan view of a rubbing apparatus according to another embodiment of the present invention, which has a step-covering means adjustable according to the size of a substrate.

As shown, the rubbing apparatus includes a stage 310 and a roller 320, and a substrate 330 is placed on the stage 310. The step-covering means 311 includes four separable bars constituting the four sides of the step-covering means 311, so that the four bars can be moved in four directions such as horizontally and vertically according to the size of the substrate 330.

The process of rubbing the substrate 330 by the rubbing apparatus is the same as that as described above.

Hereinafter, the rubbing apparatus according to the present invention will be compared with the conventional rubbing apparatus and the superiority of the rubbing apparatus according to the present invention will be described.

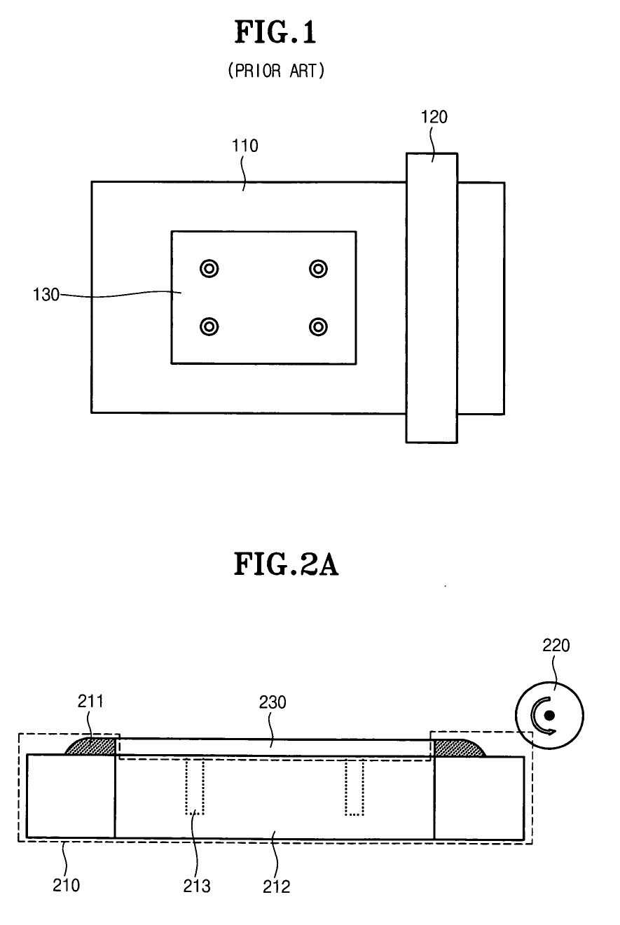

In the conventional rubbing apparatus shown in FIG. 1, the roller must pass the step between the substrate and the stage. As a result, the rubbing cloth wrapping the roller may be damaged by the step, and the alien material generated by the damage may be scattered on the substrate.

However, in the rubbing apparatus of the present invention as shown in FIGS. 2A and 2B, the roller need not pass the step due to the step-covering means. In other words, the roller moves onto the substrate after passing the step-covering means, so that the rubbing cloth wrapping the roller is prevented from being damaged and scattering of the alien material on the substrate by the damage can be reduced.

As noted from the above description, the rubbing apparatus of the present invention prevents the rubbing cloth wrapping the roller from being damaged and reduces scattering of the alien material on the substrate by the damage. As a result, the rubbing apparatus according to the present invention can manufacture an LCD of high quality while reducing the time and cost for the manufacture of the LCD.

Although preferred embodiments of the present invention have been described for illustrative purposes, those skilled in the art will appreciate that various modifications, additions and substitutions are possible, without departing from the scope and spirit of the invention as disclosed in the accompanying claims.

1. A rubbing apparatus for a liquid crystal display device, the rubbing apparatus comprising:
a stage on which a substrate is placed; and
a roller for rubbing a composite film coated on the substrate so as to form an orientation film,
wherein the stage includes:
a suction means for sucking the substrate, the suction means being movable up and down; and
a step-covering means surrounding a periphery of the substrate, the step-covering means being horizontally and vertically movable.

2. The rubbing apparatus as claimed in claim 1, wherein the step-covering means includes four members which can be moved in horizontal or vertical directions according to a size of the substrate.
